(19) United States
(12) Patent Application Publication
(10) Pub. No.: US 2009/0113186 A1
(43) Pub. Date: Apr. 30, 2009

(54) MICROCONTROLLER AND CONTROLLING SYSTEM

(75) Inventors: Naoki KATO, Kodaira (JP); Tetsuya Yamada, Sagamihara (JP); Fumio Arakawa, Kodaira (JP); Hiromichi Yamada, Hitachi (JP); Shigeru Oho, Tokyo (JP); Makoto Ishikawa, Kodaira (JP)

Correspondence Address: MILES & STOCKBRIDGE PC, 1751 PINNACLE DRIVE, SUITE 500, MCLEAN, VA, 22102-3833, US

(73) Assignee: HITACH., LTD.

(21) Appl. No.: 12/262,173

(22) Filed: Oct. 30, 2008

(30) Foreign Application Priority Data
Oct. 31, 2007 (JP) 2007-282959

(51) Int. Cl. G06F 9/22; G06F 7/42; G06F 3/00

(52) U.S. Cl. 712/222; 708/505; 710/38; 710/14; 712/E09.006

(57) ABSTRACT

A microcontroller and a controlling system having the same are provided, in which the increase in the program code for performing floating-point arithmetic, in particular, the increase in the amount of code due to a variable are suppressed, and the processing overhead for converting fixed-point data into floating-point data is reduced. The microcontroller includes a floating-point converter which inputs integer data and corresponding decimal point position data as fixed-point data and which converts the input data into floating-point data by acquiring a fraction part, an exponent part, and a sign of the floating type from the input data, and a floating-point arithmetic logic unit which receives the output of the floating-point converter and calculates the floating-point data. The floating-point converter acquires the exponent part by performing addition and subtraction of the decimal point position data and the shift amount of the fraction part to the integer data.

### CLAIM OF PRIORITY

The present application claims priority from Japanese application JP 2007-282959 filed on Oct. 31, 2007, the content of which is hereby incorporated by reference into this application.

### FIELD OF THE INVENTION

The present invention relates to a microcontroller provided with a floating-point arithmetic logic unit, more specifically, to technology which is effective when applied to a microcontroller and a controlling system using the same, where the microcontroller inputs an external signal, calculates a control signal to control an apparatus as a control object with the use of the internal floating-point arithmetic logic unit, and consequently outputs the control signal externally.

### BACKGROUND OF THE INVENTION

For example, in a controlling system (ECU) of a vehicle, etc., a control signal is generated based on information inputted from a sensor and outputted to an actuator, and the actuator operates based on the control signal. In the controlling system, a microcontroller, a driver IC, etc. are mounted. In the microcontroller mounted in the controlling system, the program was frequently described by using a fixed-point type variable in the past. The fixed-point representation is expressed by fixing in advance the number of bits used for an integer part and the number of bits used for a fraction part. The fixed-point representation can express a narrower range of value than the floating-point representation; however the fixed-point representation has an advantage that a high speed calculation is possible. In many cases, a microcontroller takes in an analog signal from a sensor and digitizes it by a built-in A/D converter. Since the built-in A/D converter has the precision of at most 10-12 bits, an internal variable is also expressed by a fixed-point type of 8 bits or 16 bits; therefore, high-speed operation, reduction of memory usage, and reduction of program codes are possible. As data representation inside a microcontroller, there is no data type which indicates a fixed point explicitly, and an integer type (16 bits and 32 bits), a character type (8 bits), etc. are usually used. A programmer itself is required to remember in which position each variable has decimal point. In addition and subtraction of the fixed-point type variables with different decimal point positions, it is necessary to carry out radix point alignment, and to include arithmetic processing, such as a division for the radix point alignment, in a program, requiring troublesome labor in programming. On the other hand, in the case of the floating point representation, automatic radix point alignment is carried out by the microcontroller itself; therefore, a programmer's labor is simplified.

Recent years, the microcontroller provided with a floating-point processor has increased in number, requiring a high data precision, enlarging a program size, and increasing request for an easy programming. These facts have stimulated the increase of the floating point operation. When a single precision floating-point representation is used, a 32-bit data area will be necessary, and the number of bits of variables and data of a program will increase compared with a fixed point expression, therefore, the amount of RAM or ROM used will increase. For example, it is often practiced in a controlling system that a table for determining a next control amount based on plural sensor values is stored in ROM as a control table. At this time, the control table expressed by a single precision floating point requires 4 times as many storage regions, compared with the case where the control table is expressed by an 8-bit fixed point. As a ROM which stores the control table, a flash memory for storing a program or constant data may be used in the exterior of the microcontroller in one case, and a nonvolatile ROM may be used in the interior of the microcontroller in another case. However, in any case, the prices of a microcontroller and also a controlling system increase as the storage capacity of the memory increases.

Document 1 discloses an invention in which, in order to reduce the amount of ROM used for a control table of a floating point, attention is paid to the fact that much data having the same value exists in the table, and a floating-point data is replaced by an index with fewer bits and a conversion table of the index and the actual value is provided separately. Accordingly, the amount of ROM used is reduced. Document 2 discloses an invention in which, when a floating point representation and fixed point representation coexist inside a microcontroller, data is held always in both expressions for the same data in order to save the labor of the calculation in conversion each time.
Document 1: Japanese Unexamined patent Publication No. 2005-201181
Document 2: Japanese Unexamined patent Publication No. 2001-195233

### SUMMARY OF THE INVENTION

The present inventors have examined that the control table is comprised of a small number of bits as the signal taken in by an A/D converter and the data of the control table is converted to a floating point when the data is used for operation inside. In this case, when reading the control table, the floating-point conversion is carried out with the program code of several instructions, therefore, the quantity of the program code increases and the processing time in conversion increases, causing the problem that performance falls. For example, in order to read an integer type variable stored in a memory and to convert into a floating type variable, the following steps are required:

(1) loading a variable from a memory to an integer register,

(2) moving the variable from the integer register to a special register of floating point,

(3) reading the variable from the special register, converting and storing the variable in a floating-point register, and

(4) performing division (multiplication) in the decimal point position using a floating-point arithmetic logic unit for fraction alignment. The above processing requires four instructions in number of instruction, ten-odd cycles in number of cycle when floating-point division is used, and about eight cycles in total even when multiplication of the inverse number is used instead of the division. Whenever an element of a large-scale control table is read, the above-described steps, especially the processing of division or multiplication, are required. Therefore, it is seen that the program code increases and many processing cycles are required. Some kinds of instruction set architecture can practice the above-described steps (2) and (3) by one instruction. However, in any cases, compared with a case where the control table of fixed point is used and operation is also practiced in fixed point, or compared with a case where the control table of floating point is used and floating-point arithmetic is practiced, the case where the control table of fixed point is used and floating-point arithmetic is practiced brings about the overhead of the increase in the program code and the increase in the processing cycle.

The present invention has been made in view of the above circumstances and provides a microcontroller which can suppress the increase in the amount of program code for carrying out a floating-point arithmetic, in particular in the amount of program code due to a variable.

The present invention also provides a microcontroller which can reduce the processing overhead for converting fixed-point data into floating-point data.

The present invention further provides the controlling system which can reduce the capacity of a control table used for floating-point arithmetic, and reduce the overhead of control processing using the storage information of the control table.

The above and other purposes and the new feature of the present invention will become clear from the description of the present specification and the accompanying drawings.

The following briefly explains an outline of typical one of the inventions disclosed by the present application.

Namely, the present invention provides a microcontroller comprising: a floating-point converter which inputs data including integer data and corresponding decimal point position data as fixed-point data into a controlling system and converts the inputted fixed-point data into floating-point data by acquiring a fraction part, an exponent part, and a sign from the inputted fixed-point data; and a floating-point arithmetic logic unit which receives the output of the floating-point converter and performs operation of the floating-point data. The floating-point converter acquires the exponent part by performing addition and subtraction of the decimal point position data and the shift amount of the fraction part for the integer data.

The following briefly explains effects obtained by typical one of the inventions disclosed by the present application.

That is, it is possible to suppress the increase in the amount of program code for performing a floating-point arithmetic, in particular the increase in the amount of program code due to a variable.

It is possible to lessen the processing overhead for converting fixed-point data into floating-point data.

It is possible to suppress the capacity of the control table used for floating-point arithmetic and to reduce the overhead of control processing using the storage information of the control table.

### BRIEF DESCRIPTION OF THE DRAWINGS

FIG. 1 is a block diagram illustrating a first example of floating-point conversion function which is provided by a microcontroller according to the present invention;

FIG. 2 is an explanatory drawing specifically illustrating the conversion operation explained in FIG. 1;

FIG. 3 is a block diagram illustrating a second example of floating-point conversion function which is provided by the microcontroller according to the present invention;

FIG. 4 is a block diagram illustrating a third example of floating-point conversion function which is provided by the microcontroller according to the present invention;

FIG. 5 is a block diagram illustrating a fourth example of floating-point conversion function which is provided by the microcontroller according to the present invention;

FIG. 6 is an explanatory drawing illustrating an example of a conversion target address table;

FIG. 7 is a block diagram illustrating a fifth example of floating-point conversion function which is provided by the microcontroller according to the present invention;

FIG. 8 is a block diagram illustrating a controlling system to which the microcontroller is applied, according to the present invention; and

FIG. 9 is a block diagram illustrating the overall constitution of the microcontroller.

### DETAILED DESCRIPTION OF THE PREFERRED EMBODIMENTS

### 1. Outline of Embodiment

First, an outline is explained about a typical embodiment of the invention disclosed in the present application. A numerical symbol in parentheses referring to a component of the drawing in the outline explanation about the typical embodiment only illustrates what is included in the concept of the component to which the numeral symbol is attached.

(1) A microcontroller comprises: a central processing unit which carries out an instruction and performs integer arithmetic; a floating-point converter which inputs data including integer data and corresponding decimal point position data as fixed-point data and converts the inputted fixed-point data into floating-point data by acquiring a fraction part, an exponent part, and a sign from the inputted fixed-point data; and a floating-point arithmetic logic unit which receives the output of the floating-point converter and carries out operation of the floating-point data.

Since the floating-point converter is employed, the increase in the amount of code due to a variable included in the program code for the floating-point arithmetic logic unit can be suppressed. Since the floating-point converter performs the conversion by inputting integer data and corresponding decimal point position data as fixed-point data, the use of decimal point position data in the conversion process does not necessitate multiplication or division for the fraction alignment to the floating-point data after the conversion, resulting in the reduced overhead of the transform processing.

(2) In the microcontroller of the item (1), the floating-point converter acquires the exponent part (EXP) by performing addition and subtraction between the decimal point position data (EXP2) and the shift amount of the fraction part for the integer data (INTDAT). The exponent part can be easily acquired by performing addition and subtraction.

(3) In the microcontroller of the item (2), the integer data includes plural bytes and the decimal point position data includes at least number of bits equal to a digit number of the integer data and the number of factorial of a factorial value of two. The decimal point position data can be expressed with few numbers of bits to the integer data.

(4) In the microcontroller of the item (3), the floating-point data is in conformity with the IEEE 754 standard for floating point representation, and the floating-point converter acquires the exponent part of the floating-point data by adding or subtracting the decimal point position data to and from the value of the exponent part to the integer data. The exponent part can be easily acquired by addition and subtraction.

(5) In the microcontroller of the item (2), the floating-point converter is activated by a floating point conversion instruction executed by the central processing unit, reads the integer data of the fixed-point data from an integer register (33) specified by an instruction operand of the instruction, and stores the converted floating-point data to a floating-point register (35) specified by the instruction operand of the instruction. The conversion to the floating type can be performed by the process in which the central processing unit executes the floating point conversion instruction.

(6) In the microcontroller of the item (5), the integer register and the floating-point converter are coupled by a first bus, and the floating-point converter and the floating-point register are coupled by a second bus. At the time of the conversion by the floating-point converter, control of the data path becomes very easy.

(7) In the microcontroller of the item (6), the floating-point converter inputs a decoded result of the instruction operand of the floating point conversion instruction as the decimal point position data. Although the instruction code length of the floating point conversion instruction increases, specification of the decimal point position data does not require any other instruction.

(8) In the microcontroller of the item (6), the floating-point converter is inputted the decimal point position data stored in a predetermined register (40) by the central processing unit. In this case, the decimal point position data can be specified without increasing the instruction code length of the floating point conversion instruction. Since it is common to arrange uniformly the decimal point position of the fixed-point data used for a group of processing, it is not necessary to redo the register setup each time for every floating-point conversion.

(9) The microcontroller of the item (2) has a first operation mode and a second operation mode which are selectively employed when the central processing unit executes a data transfer instruction to transfer data from a memory to the floating-point register of the floating-point arithmetic logic unit. In the first operation mode, data in the memory is directly loaded to the floating-point register. In the second operation mode, data in the memory is converted into floating-point data by the floating-point converter and the converted data is stored in the floating-point register. The floating-point data stored in the memory can be directly used for the floating-point arithmetic.

(10) The microcontroller of the item (9) further comprises: a selector (51) which selects a first path along which the data read from the memory by the data transfer instruction is provided to the floating-point register when the first operation mode is specified, and which selects a second path along which the data read from the memory by the data transfer instruction is provided to the floating-point converter when the second operation mode is specified. It is possible to easily practice the data path selection between in the case where the floating-point data taken from the memory is used for the floating-point arithmetic directly and in the case where the floating-point data converted by the floating-point converter is used for the floating-point arithmetic.

(11) In the microcontroller of the item (9), the first operation mode and the second operation mode can be switched over according to a flag value set in a mode register (50).

(12) The microcontroller of the item (9) further comprises: a data table (61) which has operation mode designating data and necessary decimal point position data corresponding to a memory address. The data table (61) inputs a memory access address by the data transfer instruction and outputs the operation mode designating data and the decimal point position data corresponding to the memory address concerned. One of the first operation mode and the second operation mode is selected based on the output of the data table. The floating-point converter acquires the necessary decimal point position data from the output of the data table. In accordance with the acquisition of data as a conversion target, the corresponding operation mode designating data and the necessary decimal point position data can be obtained automatically.

(13) In the microcontroller of the item (9), the floating-point converter inputs decimal point position data stored in a predetermined register by the central processing unit.

(14) The microcontroller of the item (1) further comprises: a direct memory access controller which is subject to condition setting by the central processing unit; and a memory which stores the integer data. The direct memory access controller can transfer the integer data from the memory to the floating-point converter in response to a transfer request. The floating-point conversion can be realized not only by the execution of the conversion instruction by the central processing unit, but also by the direct memory access transfer control.

(15) In the microcontroller of the item (14), the direct memory access controller can transfer to the memory the floating-point data converted by the floating-point converter and stored in a floating-point register. The operation mode which stores beforehand plural conversion results in a memory to be used in floating-point arithmetic also becomes selectable.

(16) In the microcontroller of the item (15), the floating-point converter inputs decimal point position data stored in a predetermined register by the central processing unit. It becomes possible to specify the decimal point position data when the central processing unit sets up the transfer condition to the direct memory access controller.

(17) In the microcontroller of the item (16), the direct memory access controller has the predetermined register. Specification of the decimal point position data becomes easy.

(18) A controlling system comprises: a control unit (70); an actuator (71) of which control amount is determined by the control unit; and a sensor (72) which detects state of a control object of the actuator. The control unit includes a program memory (90) storing a control program in which a variable is expressed by floating-point representation; a control table memory (91) storing control data expressed by a fixed-point integer; a floating-point converter (32); and a floating-point arithmetic logic unit (38). The floating-point converter gets input data including control data and corresponding decimal point position data. The input data is read from the control table memory based on input from the sensor. The floating-point converter converts the input data into floating-point data by acquiring a fraction part, an exponent part, and a sign in a floating-point type from the input data. The floating-point arithmetic logic unit gets output of the floating-point converter and carries out floating-point data operation based on the control program.

Since the floating-point converter is employed, the increase in the amount of code due to a variable included in the program code for the floating-point arithmetic logic unit can be suppressed. Since the floating-point converter performs the conversion by inputting integer data and corresponding decimal point position data as fixed-point data, the use of decimal point position data in the conversion process does not necessitate multiplication or division for the fraction alignment to the floating-point data after the conversion, resulting in the reduced overhead of the conversion processing. Since what is necessary is that a control table memory has, as the integer data, the control data to be used to determine the control amount in a controlling system, the storage capacity of the control table memory can be suppressed.

(19) In the controlling system of the item (18), the floating-point converter acquires the exponent part by performing addition and subtraction of the decimal point position data and the shift amount of the fraction part for the integer data. The exponent part can be easily acquired by addition and subtraction.

(20) The controlling system of the item (18) further comprises: a central processing unit which reads out control data from the control table memory based on input from the sensor and which provides the read-out control data to the floating-point converter.

(21) In the controlling system of the item (20), the floating-point converter inputs, as the decimal point position data, a decoded result of an instruction operand of floating point conversion instruction executed by the central processing unit.

(22) In the controlling system of the item (20), the floating-point converter inputs the decimal point position data stored in a predetermined register by the central processing unit.

(23) In the controlling system of the item (18), the program memory, the floating-point converter, and the floating-point arithmetic logic unit are formed over a same semiconductor chip. This formation contributes to miniaturization of the controlling system.

### 2. Details of Embodiment

The embodiment is explained further in full detail. Hereafter, the best mode for carrying out the present invention is explained in detail based on the accompanying drawings. In all the drawings for explaining the best mode for inventing, the same symbol is attached to the member which has the same function, and the duplicated explanation thereof is omitted.

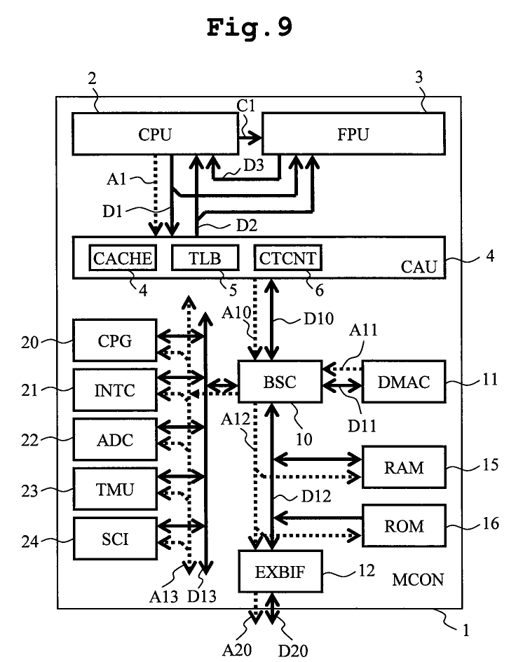

FIG. 9 is a block diagram illustrating the overall constitution of the microcontroller. Although not restricted in particular, a microcontroller 1 illustrated is formed over a piece of a semiconductor substrate such as single crystal silicone, by manufacturing technology of a complementary-type MOPS integrated circuit.

Although not restricted in particular, the microcontroller (MCON) 1 includes a central processing unit (CPU) 2, a floating-point processing unit (FPU) 3, and a cache unit (CAU) 4, as a processor core. The CPU 2 executes a fetched instruction and performs integer arithmetic. The FPU 3 executes a floating-point arithmetic instruction and performs floating-point arithmetic. Moreover, the FPU 3 converts to the fixed-point data supplied into the floating-point data. The cache unit 4 includes a cache memory (CACHE) 5, a translation look-aside buffer (TLB) 6, and a cache-TLB control circuit (CTCNT) 7. The cache memory stores temporarily an instruction and data which are with high use frequency. The TLB 6 holds temporarily a conversion pair of a logical address and a physical address which are with high use frequency. The CTCNT 7 performs: address conversion control to the address information outputted from the CPU 2; control of the replacement and fill operation of cache entry, corresponding to cache hit/cache miss of the cache memory to an access request by the CPU 2; control of the replacement and fill operation, corresponding to TLB hit/TLB miss of the TLB 6; and other controls. In FIG. 9, a symbol Al denotes an address bus and symbols D1-D3 denote data buses. Although not restricted in particular, the CPU 2 performs addressing to the data which the FPU 3 uses. A symbol C1 denotes a control signal bus from the CPU 2 to the FPU 3.

The CAU 4 is coupled to a bus state controller (BSC) 10 via an address bus A10 and a data bus D10. The BSC 10 is coupled to an external bus interface circuit (EXBIF) 12 via an address bus A12 and a data bus D12. The EXBIF 12 is coupled to external devices, such as an external memory, via an external address bus A20 and an external data bus D20. A random access memory (RAM) 15 and a read-only memory (ROM) 16 are coupled to the address bus A12 and the data bus D12. The BSC 10 is coupled to peripheral circuit modules 20-24 via a peripheral address bus A13 and a peripheral data bus D13. The peripheral circuit module 20 is a clock pulse generator (CPG) which generates a synchronous clock signal inside the MCON 1. The peripheral circuit module 21 is an interruption control circuit (INTC), and outputs an interrupt signal to the CPU 2 in response to an interruption request signal from the inside and outside of the MCON 1. The peripheral circuit module 22 is an analog/digital converter (ADC) which converts an analog signal from the outside into a digital signal. The peripheral circuit module 23 is a timer counter unit (TMU). The peripheral circuit module 24 is a serial interface circuit (SCI). The BSC 10 is coupled to a direct memory access controller (DMAC) 11 via an address bus A11 and a data bus D11. A transfer condition for the direct memory access controller (DMAC) 11 is set up by the CPU 2. By receiving a transfer request, the direct memory access controller (DMAC) 11 performs a data transfer control, according to the transfer condition, by dual addressing mode such as in transfer between a memory and a memory, or a single addressing mode such as in transfer between a memory and a register. The BSC 10 performs a bus control, such as a number of bus cycle, a data width, and a path selection, according to the access address supplied from the bus A10.

The following explains the conversion function in converting fixed-point data into floating-point data using the FPU 3.

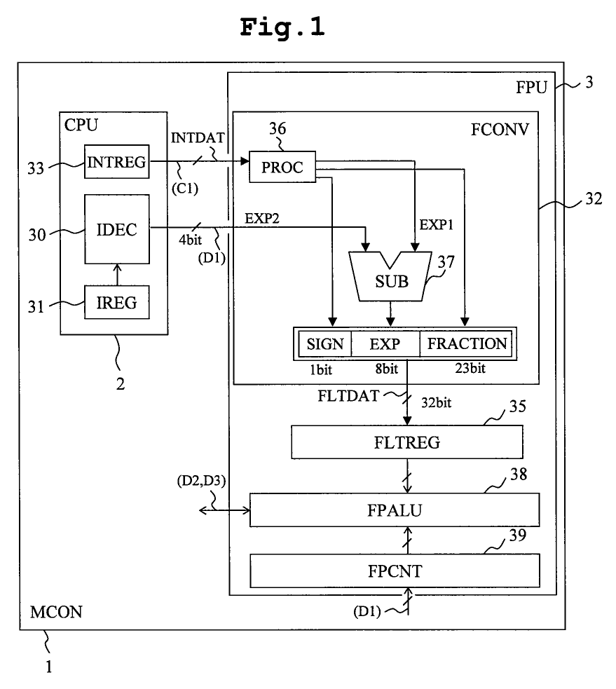

FIG. 1 is a block diagram illustrating a first example of floating-point conversion function which is provided by the MCOM 1. When an instruction decoder (IDEC) 30 included in the CPU 2 decodes a floating point conversion instruction fetched to an instruction register (IREG) 31, integer data INTDAT is transferred to a floating-point converter (FCONV) 32 from an integer register (INTREG) 33 specified by an instruction operand of the instruction. The integer register 33 stores the fixed-point integer data INTDAT which is expressed by the integer type of 8 bits or 16 bits for example and which is to be converted to floating-point data. The instruction decoder 30 transfers to the floating-point converter 32 information (decimal point position data) EXP2 which indicates the decimal point position specified by the operand of the floating point conversion instruction concerned. Since the fixed-point data is of 8 bits or 16 bits, information of at most 4 bits is sufficient for the decimal point position data EXP2. The floating-point converter 32 converts the fixed-point data, which is specified by the integer data INTDAT and the decimal point position data EXP2 of the integer data, to floating-point data FELTDAT of single precision, and outputs the converted floating-point data FLTDAT to a floating-point register (FELTREG) 35.

The floating-point converter 32 has a sign-and-fraction processing unit (PROC) 36 and a subtractor (SUB) 37 which calculates the exponent part. Since the integer type expression usually expresses a negative value by a two's complement, the symbol can be distinguished by investigating whether a highest-order bit is “1” or “0”, and the sign-and-fraction processing unit 36 outputs one-bit sign information SIGN. The sign-and-fraction processing unit 36 calculates an exponent part EXP1 and a fraction part FRACTION. Since the processing by the sign-and-fraction processing unit 36 which calculates the sign SIGN, the exponent part EXP1, and the fraction part FRACTION is known technology, the explanation about the portion is made simply. The sign-and-fraction processing unit 36 calculates the place of “1” in the highest order from the inputted integer representation, and shifts the bit to the left so that the bit may come to the highest-order bit. In the floating point representation, since the hidden bit which omits the highest order “1” is used, the sign-and-fraction processing unit 36 shifts the bit to the left by one more bit, and fills “0” into the vacant right bit portion. As a result, a final fraction part FRACTION is calculated. In the case of a negative value whose highest-order bit is “1”, the complement is calculated by subtracting one and the absolute value is calculated, then the same treatment is taken. The sign-and-fraction processing unit 36 calculates the exponent part EXP1 by the digit number of the place of “1” in the highest order. The subtractor 37 inputs the exponent part EXP1 calculated and the decimal point position data EXP2, reduces the decimal point position data EXP2 from the exponent part EXP1, and calculates the exponent part EXP in the final floating point representation. When the decimal point position to the integer data INTDAT is located on the right, the decimal point position data is given as a complement. Accordingly, even in a case where the decimal point position is located on the lowest right-hand side of the integer data, the exponent part EXP can be calculated by subtraction with the subtractor 37. When the complement is adopted for the decimal point position data EXP2, an adder may be used instead of the subtractor.

The sign information SIGN, the exponent part EXP, and the fraction part FRACTION which are obtained as described above are combined to 32-bit data and outputted to the floating-point register 35. The floating-point data loaded to the floating-point register 35 is treated as a target of floating-point arithmetic to be performed by a floating-point arithmetic logic unit (FPALU) 38. The floating-point arithmetic logic unit 38 also treats the floating-point data loaded to the other floating-point registers (not shown) as a target of the arithmetic, if needed. A floating-point control circuit (FPCNT) 39 decodes the floating point instruction supplied from the CPU 2, and controls the arithmetic operation by the floating-point arithmetic logic unit 38.

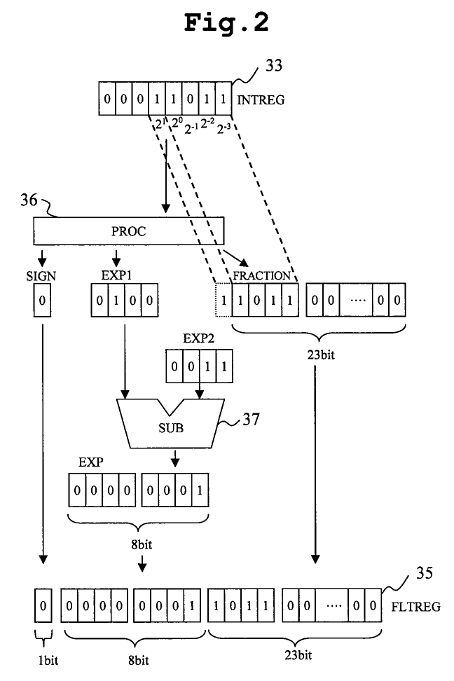

FIG. 2 is an explanatory drawing specifically illustrating the conversion operation explained in FIG. 1. It is assumed that a value “00011011” is stored in the integer register (INTREG) 33. It is also assumed that the decimal point position data EXP2 indicates “0011”, or, the decimal point is in the left of the third lowest bit. Therefore, the value of the fixed-point data specified by the value of the integer register (INTREG) 33 and the value of EXP2 is “11.011” when expressed in a binary digit. In a decimal digit, the value of the fixed-point data expresses “1×2¹+1×2⁰+0×2⁻¹+1×2⁻²+1×2⁻³=3.375.” The sign-and-fraction processing unit (PROC) 36 outputs “0” indicating the positive for the sign bit SIGN by the highest-order bit judgment. In the processing which calculates the fraction part FRACTION, a value “1” in the highest order is first found at the 5th bit from the lowest bit. In the floating-point number, since the integer part of the fraction part is always set to “1” and the highest order “1” is omitted, four bits from the lowest bit of the integer register 33 are put into the fraction part FRACTION at left filling, and value “0” is filled into all the remainder of the fraction part FRACTION. This operation calculates at the same time that the exponent part EXP1 is “0100” in binary, i.e., “4” in decimal. Since the original integer representation is a fixed point which has the decimal point in the left of the lowest third bit, the exponent part EXP can be calculated by “the exponent part EXP1—the decimal point position data EXP2”, accordingly the exponent part EXP of “1” is calculated.

Although the present example has explained as subtraction, the present example can be alternatively realized taking a complement and using an adder. Accordingly, the value 1.1011×2¹ of the converted floating point is outputted to the floating-point register (FLREG) 35.

As it can be understood from the explanation of FIG. 2, the processing to calculate the exponent part EXP is a subtraction or an add operation of at most 4 bits and the processing to calculate the fraction part FRACTION is only to acquire the highest order “1” out of 8-16 bits. Therefore, the conversion and the radix point alignment can be realized at very high speed, compared with the case where the division of the floating-point number is performed for the radix point alignment, after performing the floating-point conversion. Since the division process instruction for the radix point alignment is not required, the number of instruction needed in conversion is also reducible.

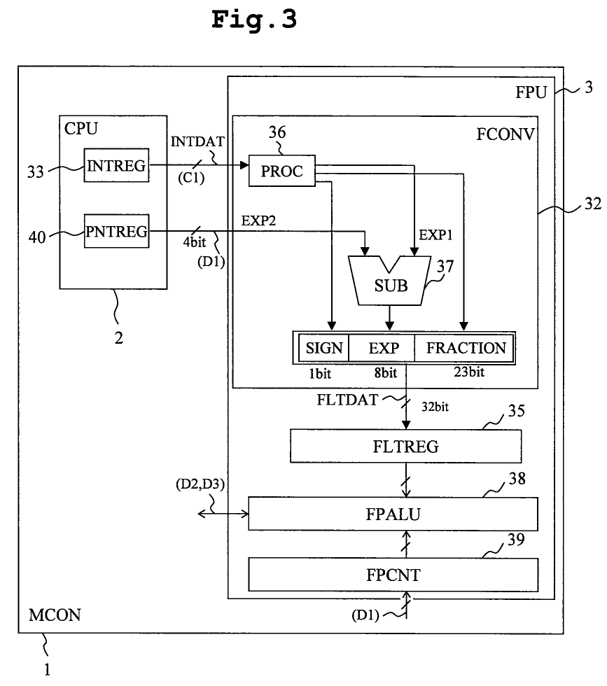

FIG. 3 is a block diagram illustrating a second example of the floating-point conversion function which is provided by the MCON 1. What is different from FIG. 1 is as follows. The decimal point position data EXP2 is not transferred to the floating-point converter 32 by the instruction operand of the floating point conversion instruction. Instead, the decimal point position data EXP2 is stored beforehand in a decimal point position register (PNTREG) 40, and when the converter 32 is activated by the floating point conversion instruction, the decimal point position data EXP2 is acquired by referring to the register 40. Although the instruction decoder 30 and the other elements included in the CPU 2 which are illustrated in FIG. 1 are not illustrated in FIG. 3, the instruction decoder 30 and the other elements are provided also in the constitution of FIG. 3. In FIG. 3, although the decimal point position register 40 is arranged inside the CPU 2, the decimal point position register 40 is not necessarily restricted to the case, but may be arranged inside the floating-point converter 32. The operation of the floating-point converter 32 is the same as in FIG. 1.

Since the constitution of FIG. 3 does not need to include the decimal point position data in the operand of the floating point conversion instruction, the advantage is that the instruction can be expressed compactly. On the other hand, it is necessary to set the decimal point position data to the decimal point position register 40 in advance. The setup to the decimal point position register 40 may be performed by the CPU 2 which executes a data transfer instruction etc. Although several kinds of control tables with respect to the fixed point representation are used in a controlling system, within one control table, unification of the decimal point position is usually achieved. Therefore, in a series of processing units in which access is made to one control table, it can be expected that the floating point conversion instruction can be executed, without changing the decimal point position register 40. Therefore, the increase of program codes or the overhead of the processing time due to the additional instructions for the setup of the decimal point position register 40 do not become a problem substantially.

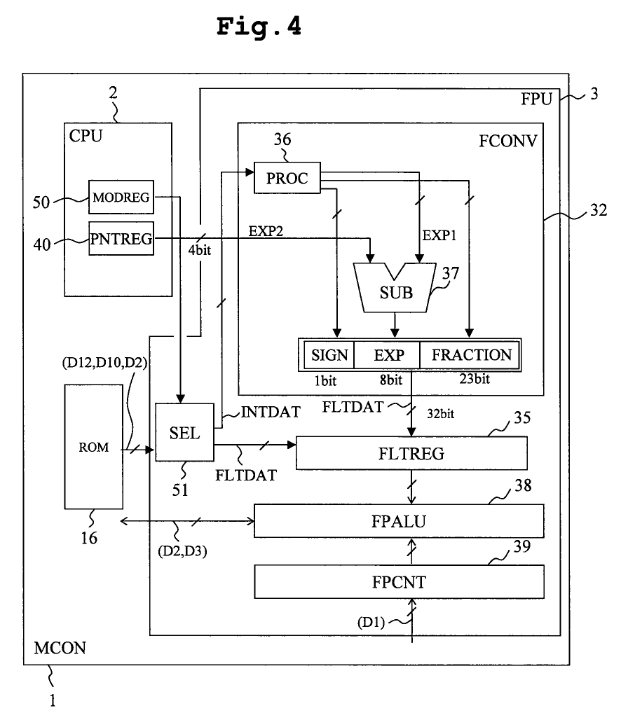

FIG. 4 is a block diagram illustrating a third example of the floating-point conversion function which is provided by the MCON 1. In FIG. 4, the floating-point converter (FCONV) 32 is operated by the instruction of data transfer from a ROM 16 to the floating-point register 35. By the setting value of a mode register (MODREG) 50, it is possible to switch between a second operation mode which performs a floating-point conversion and a first operation mode which does not perform a floating-point conversion, in the data transfer from the ROM 16 to the floating-point register (FLTREG) 35. Therefore, the mode register 50 is sufficient to have a one-bit flag. The mode register 50 may not be restricted to be an internal register of the CPU 2, but may be a register inside the FPU 3. A selector (SEL) 51 selects a path through which the read data of the ROM 16 of which the address is specified by the instruction operand of the data transfer instruction is transferred. One path is led directly to the floating-point register 35 via the selector (SEL) 51, and another path is led to the sign-and-fraction processing unit 36 of the floating-point converter 32 via the selector (SEL) 51. The path selection by the selector 51 is controlled by the setting value of the mode register 50. That is, in the case where the data which is read-accessed from the ROM 16 is the integer data of fixed point representation which should be converted to a floating point, the path leading to the floating-point converter 32 is selected, and in the case where the data which is read-accessed from the ROM 16 is the floating-point data originally, the path leading directly to the floating-point register 35 is selected. Illustration of a BSC 10, a CAU 4, etc. is omitted in FIG. 4.

According to the constitution of FIG. 4, in a series of processing units in which the control table expressed in one fixed point is accessed, it is possible to perform control in the following way. That is, integer data is converted to floating-point data in advance and is stored in the ROM 16, the second operation mode is set up if needed, and the floating-point data is transferred from the ROM 16 to the floating-point register 35 directly. Accordingly, neither the program code for the setup of the mode register 50 nor the overhead of the processing time becomes a problem. However, the storage capacity of the ROM 16 becomes larger as much as the floating-point data to be stored.

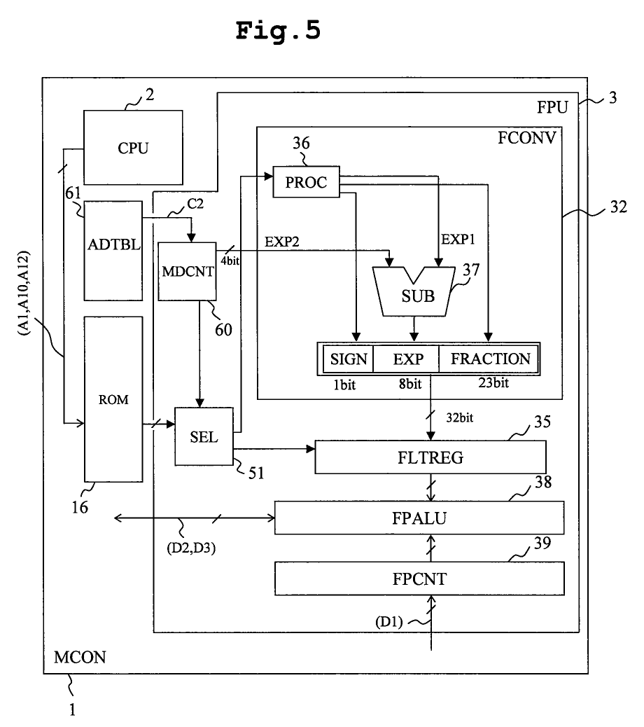

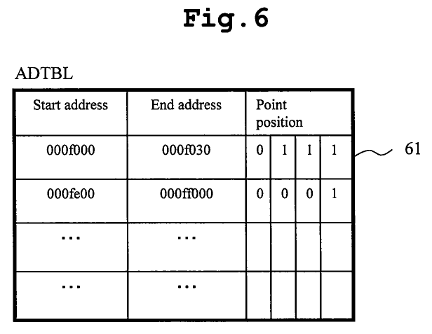

FIG. 5 is a block diagram illustrating a fourth example of the floating-point conversion function which is provided by the MCON 1. In FIG. 5, same as in FIG. 4, the floating-point converter (FCONV) 32 is operated by the data transfer instruction from the ROM 16 to the floating-point register 35. The difference with FIG. 4 is that a mode controller (MDCNT) 60 and a conversion target address table (ADTLB) 61 are employed instead of the mode register. With reference to the conversion target address table 61, the mode controller 60 makes the selector 51 select the path to the floating-point converter 32 only in the case where the address of the transfer source specified by the transfer instruction is registered in the conversion target address table 61. When the address of the transfer source specified by the transfer instruction is not registered in the conversion target address table 61, the mode controller 60 makes the selector 51 select the path leading to the floating-point register 35 directly. The conversion target address table 61 is formed by using a content-addressed memory for example in the CAU 4, and may supply the address of the transfer source to the mode controller 60 via a control line C2 (illustration is omitted in FIG. 9). Although not restricted in particular, the mode controller 60 is arranged in the FPU 3. The decimal point position data EXP2 is stored in the conversion target address table 61 for every address range specified. Therefore, the decimal point position data EXP2 is transferred to the floating-point converter 32 via the mode controller 60. FIG. 6 is an explanatory drawing illustrating an example of the conversion target address table 61. The conversion target address table 61 can store plural sets of a start address (Start address) STRTaddr, an end address (End address) ENDaddr, and decimal point position data (Point Position) EXP2 of the floating-point conversion target. The conversion target address table 61 also has the function to determine whether the access address is within the address range stored, and to output the decimal point position data EXP2 corresponding to the address range of the determination hit, together with the determination result. The size data which meets the address range of the conversion target may be stored instead of the end address. Illustration of a BSC 10, a CAU 4, etc. is omitted in FIG. 5.

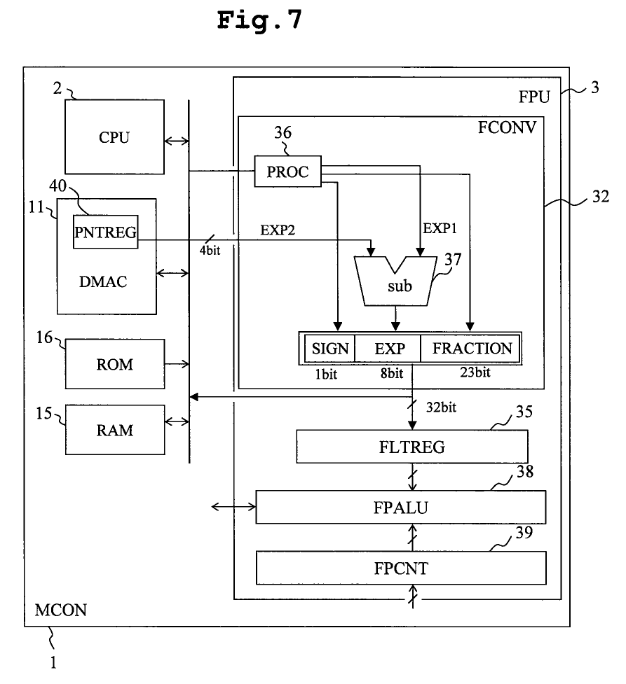

FIG. 7 is a block diagram illustrating a fifth example of the floating-point conversion function which is provided by the MCON 1. In FIG. 7, using the direct memory access transfer by a DMAC 11, the fixed-point data stored in the ROM 16 is converted into floating-point data by the floating-point converter 32, and the converted data is transferred to the floating-point register 35 or a RAM 15. Transfer control information necessary for the transfer is set up to the DMAC 11 by the instruction executed by the CPU 2. The transfer control information includes, for example, the memory address of the ROM 16 as a transfer source, the memory address of the floating-point register 35 or the RAM 15 as a transfer destination, decimal point position data, etc. The decimal point position data is set in a decimal point position register (PNTREG) 40. The DMAC 11, to which the transfer control information has been set, starts the data transfer control according to the transfer control information concerned in response to a transfer request. Although not restricted in particular, the transfer control mode is a first mode by a single addressing mode from the ROM 16 to the FPU 3, or a second mode by a single addressing mode from the FPU 3 to the RAM 15. In the transfer in the first mode, the FPU 3 enables the conversion operation of the FCONV 3 and enables loading of the conversion result to the floating-point register 35. When a DMA transfer request is issued in this state, the FCONV 32 converts the integer data read from the ROM 16 into floating-point data using the value of the PNTREG 40, and loads the floating-point data to the FLTREG 35. In the transfer in the second mode, the FPU 3 enables output of the data of the FLTREG 35. When the FPU 3 issues a DMA transfer request in this state for example, the FPU 3 outputs the floating-point data of the FLTREG 35 in response to an acknowledgment signal returned from the DMAC 11, and the RAM stores the outputted data. Illustration of a BSC 10, a CAU 4, etc. is omitted in FIG. 7.

According to this example, in addition to performing the floating-point conversion of data in the control table and storing the data in the floating-point register, it is possible to perform the floating-point conversion of the data of one row of the table collectively and to store the data in the RAM. It is also possible to perform the floating-point conversion of data of one column of the table collectively and to store the data in the RAM. Alternatively, using a scatter-gather function, still more intricate conversion and transfer are possible, such as performing the floating-point conversion of data in the neighborhood of the aimed point of an n-dimension table collectively, and storing the data in the RAM.

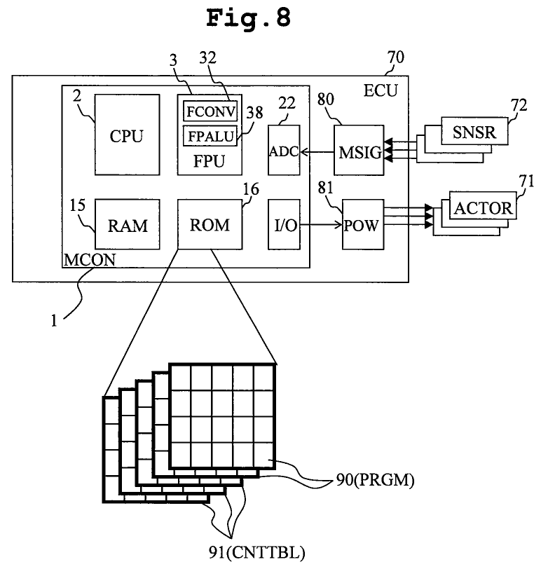

FIG. 8 is a block diagram illustrating a controlling system to which the microcontroller 1 is applied. The controlling system illustrated in FIG. 8 includes a control unit (ECU) 70, an actuator (ACTOR) 71 of which the control amount is determined by the control unit 70, and a sensor (SNSR) 72 which detects the state of a control object by the actuator 71. The control unit 70 has a microcontroller (MCON) 1, a signal processing chip (MSING) 80, and a drive element (POW) 81. In FIG. 8, illustration of other mounted circuits is omitted. The microcontroller 1 inputs a signal from the plural sensors 72 via the signal processing chip 80. The inputted signal in analog quantity is converted into digital data by an ADC 22. It is also possible to directly input data into the MCON 1, without passing the signal processing chip 80. In the case of a vehicle controlling system, the sensor signals are a number of engine rotation, an inhalation air content, a valve angle, a cam lift amount, an air temperature, etc., for example. The drive element 81 is supplied with driving data from the input/output circuit (I/O) of the MCON 1, and controls operation of the actuator according to the magnitude, etc. of the driving data. A ROM 16 of the microcontroller 1 has a control program (PRGM) 90 in which a variable is expressed in floating point. A control table (CNTTBL) 91 which has control data expressed by a fixed-point integer is provided in the ROM 16. The floating-point conversion circuit 32 of the FPU 3 inputs the control data and the corresponding decimal point position data, read from the ROM 16 based on the input from the sensor 72, and converts the input data into floating-point data by calculating the fraction part, exponent part, and sign of a floating type from the input data. As for the conversion function, any one of what have been described above can be employed; therefore, the detailed explanation thereof is omitted here. A floating-point arithmetic logic unit 38 of the FPU 3 receives the output of the floating-point converter 32, and carries out floating-point data operation based on the control program of the ROM 16.

The control table 91 of the ROM 16 is comprised of fixed-point data of 8-bit or 16-bit integer representation. The control program 90 is similarly stored in the ROM. From the state of the control object acquired by the sensor, the control amount is determined according to the control program 90, with reference to the control table 91, and is outputted from an I/O as a control signal. The variable of the program is expressed in a floating point. As explained with reference to FIG. 1 thru FIG. 7, the fixed-point data of 8-bit or 16-bit integer representation in the control table 91 is converted to the floating-point data by the floating-point converter 32, and is used in the control program 90 as floating-point data.

Accordingly, it becomes possible to reduce the size of the ROM 16. Since the control program employs a variable of a floating-point number, the control program is highly precise and manual coding can be decreased as much as possible. Moreover, the increase in the code size for conversion and the cycle overhead of the conversion process can be also reduced.

In the above, the invention accomplished by the present inventors has been specifically explained based on the embodiments. However, it cannot be overemphasized that the present invention is not restricted to the embodiments, and it can be changed variously in the range which does not deviate from the gist.

For example, the circuit module which the microcontroller has is not restricted to FIG. 9, but can be changed suitably. The cache memory and/or the translation look-aside buffer may not be employed. The bus connection mode of the bus state controller and the DMAC can be changed suitably. The RAM and the ROM may not be an on-chip. The microcontroller and the controlling system of the present invention are widely applicable to built-in controlling systems, such as vehicle control, factory control, and control of operation of a robot, etc. In particular, the microcontroller and the controlling system of the present invention are preferred for the vehicle control of recent years in which the control program becomes sophisticated and the control table grows huge and the improvement in the control accuracy is required.

What is claimed is:

1. A microcontroller comprising:
a central processing unit operable to carry out an instruction and to perform integer arithmetic;
a floating-point converter operable to input data including integer data and corresponding decimal point position data as fixed-point data and to convert the inputted fixed-point data into floating-point data by acquiring a fraction part, an exponent part, and a sign from the inputted fixed-point data; and
a floating-point arithmetic logic unit operable to receive the output of the floating-point converter and to carry out operation of the floating-point data.

2. The microcontroller according to claim 1,
wherein the floating-point converter acquires the exponent part by performing addition and subtraction of the decimal point position data and the shift amount of the fraction part for the integer data.

3. The microcontroller according to claim 2,
wherein the integer data includes a plurality of bytes, and the decimal point position data includes at least number of bits equal to a digit number of the integer data and the number of factorial of a factorial value of two.

4. The microcontroller according to claim 2,
wherein the floating-point converter is activated by a floating point conversion instruction executed by the central processing unit, reads the integer data of the fixed-point data from an integer register specified by an instruction operand of the instruction, and stores the converted floating-point data to a floating-point register specified by the instruction operand of the instruction.

5. The microcontroller according to claim 4,
wherein the integer register and the floating-point converter are coupled by a first bus, and the floating-point converter and the floating-point register are coupled by a second bus.

6. The microcontroller according to claim 5,
wherein the floating-point converter inputs a decoded result of the instruction operand of the floating point conversion instruction as the decimal point position data.

7. The microcontroller according to claim 5,
wherein the floating-point converter inputs the decimal point position data stored in a predetermined register by the central processing unit.

8. The microcontroller according to claim 2,
wherein the microcontroller has a first operation mode and a second operation mode which are selectively employed when the central processing unit executes a data transfer instruction to transfer data from a memory to the floating-point register of the floating-point arithmetic logic unit,
wherein in the first operation mode, data in the memory is directly loaded to the floating-point register, and
wherein in the second operation mode, data in the memory is converted into floating-point data by the floating-point converter and the converted data is loaded to the floating-point register.

9. The microcontroller according to claim 8, further comprising:
a selector operable to select a first path along which the data read from the memory by the data transfer instruction is provided to the floating-point register when the first operation mode is specified, and to select a second path along which the data read from the memory by the data transfer instruction is provided to the floating-point converter when the second operation mode is specified.

10. The microcontroller according to claim 8,
wherein the first operation mode and the second operation mode can be switched over according to a flag value set in a mode register.

11. The microcontroller according to claim 8, further comprising:
a data table having operation mode designating data and necessary decimal point position data corresponding to a memory address, the data table being operable to input a memory access address by the data transfer instruction and to output the operation mode designating data and the decimal point position data corresponding to the memory address concerned,
wherein one of the first operation mode and the second operation mode is selected based on the output of the data table, and
wherein the floating-point converter acquires the necessary decimal point position data from the output of the data table.

12. The microcontroller according to claim 8,
wherein the floating-point converter inputs decimal point position data stored in a predetermined register by the central processing unit.

13. The microcontroller according to claim 1, further comprising:
a direct memory access controller subject to condition setting by the central processing unit; and
a memory storing the integer data,
wherein the direct memory access controller can transfer the integer data from the memory to the floating-point converter in response to a transfer request.

14. The microcontroller according to claim 13,
wherein the direct memory access controller can transfer to the memory the floating-point data converted by the floating-point converter and stored in a floating-point register.

15. The microcontroller according to claim 14,
wherein the floating-point converter inputs decimal point position data stored in a predetermined register by the central processing unit.

16. A controlling system comprising:
a control unit;
an actuator of which control amount is determined by the control unit; and
a sensor operable to detect state of a control object of the actuator,
wherein the control unit includes:
a program memory storing a control program in which a variable is expressed by floating-point representation;
a control table memory storing control data expressed by a fixed-point integer;
a floating-point converter operable to get input data including control data and corresponding decimal point position data, the input data being read from the control table memory based on input from the sensor, and operable to convert the input data into floating-point data by acquiring a fraction part, an exponent part, and a sign in a floating-point type from the input data; and
a floating-point arithmetic logic unit operable to get output of the floating-point converter and operable to carry out floating-point data operation based on the control program.

17. The controlling system according to claim 16,
wherein the floating-point converter acquires the exponent part by performing addition and subtraction of the decimal point position data and the shift amount of the fraction part for the integer data.

18. The controlling system according to claim 16, further comprising:
a central processing unit operable to read out control data from the control table memory based on input from the sensor and operable to provide the read-out control data to the floating-point converter.

19. The controlling system according to claim 18,
wherein the floating-point converter inputs, as the decimal point position data, a decoded result of an instruction operand of floating point conversion instruction executed by the central processing unit.

20. The controlling system according to claim 18,
wherein the floating-point converter inputs the decimal point position data stored in a predetermined register by the central processing unit.
